(19) United States
(12) Patent Application Publication
(10) Pub. No.: US 2017/0243164 A1
(43) Pub. Date: Aug. 24, 2017

(54) PRODUCTION WORKER ONBOARDING AND COMPLIANCE SYSTEM

(71) Applicant: DISC Intellectual Properties, LLC, Burbank, CA (US)

(72) Inventors: David Kramer, Austin, TX (US); Amy Harken, Burbank, CA (US); Tracy Stevens, Carlsbad, CA (US); Jenelle Rotenberg, Santa Monica, CA (US)

(21) Appl. No.: 15/048,091

(22) Filed: Feb. 19, 2016

(51) Int. Cl. G06Q 10/10

(52) U.S. Cl. CPC G06Q 10/1053

(57) ABSTRACT

Systems and methods are provided for managing work engagements with prospective hires for a media production. A setup manager enters information regarding the production into an onboarding computer system, and a hiring manager enters the deal terms for a work engagement with a prospective hire, who then receives an email containing a link to an onboarding application. The onboarding application presents the prospective hire with details about the work engagement and guides the prospective hire through a series of screens in which the prospective hire enters information needed for the work engagement and reviews employment documentation, such as workplace policies or other legal documentation.

### BACKGROUND

In the entertainment industry, when starting a new production, such as a film, television or commercial production, a large number of personnel must be hired to perform the various functions required to complete the production. Traditionally, in addition to ensuring that a high-quality product is made, the production company must create, distribute, track, review, correct, submit and file numerous forms and other employment paperwork for every member of the production, referred to herein as production workers, and ensure ongoing compliance with all applicable employment and other related laws and regulations. Because production workers in the entertainment industry are typically hired on multiple productions a year, this process is repeated for each new production.

This process is burdensome and prone to error, which can result in disputes between the production company and its production workers, as well as potential violations of applicable employment and other related laws and regulations.

Accordingly, there is a need for improved systems for managing the production worker onboarding process, particularly in the entertainment industry.

### SUMMARY

Systems and methods are provided for managing a workforce and managing work engagements with prospective hires for a media production. For a media production, such as a film, television or commercial production, a setup manager enters information regarding the production into an onboarding computer system, including identifying the hiring managers, approvers, and employment documentation verifiers. The hiring manager enters the deal terms for a work engagement with a prospective hire, who then receives an email containing a link to the onboarding website. When the prospective hire logs into the website for the onboarding application, the site presents the prospective hire with the deal terms and guides the prospective hire through a series of screens in which the prospective hire enters information needed for the work engagement and reviews employment documentation, such as studio policies, payroll start paperwork, entertainment union documents, and other legal documentation (e.g., Internal Revenue Service (“IRS”) forms and their state equivalents). The site uses the information entered by the prospective hire to customize the prompts for information and display of employment documentation for that prospective hire's particular situation (e.g., job title, work location, citizenship, etc.) so that only information relevant to that prospective hire's work engagement is requested and presented. After the prospective hire approves the deal terms and employment documentation, the work engagement is presented to one or more designated approvers who provide the final approval of the work engagement. In the event one or more of the deal terms are modified by an approver, electronic notifications of the modification are transmitted to the prospective hire asking them to log into the system and agree to the new terms. In some embodiments, electronic notifications of the modification are also transmitted to other parties, such as the hiring manager or other approvers. On the production worker's first day of work, an employment eligibility verifier at the production company will review and confirm the production worker's employment eligibility documentation, such as a passport or permanent resident card, and record that confirmation in the onboarding system for future reference and review. Throughout this process, the prospective hire can log into the system to retrieve copies of the employment documentation and deal terms, and the hiring managers, approvers, and employment eligibility verifiers can access online dashboards displaying the status of all of the work engagements relevant to that manager, approver, or verifier.

In accordance with embodiments of the present invention, a computer-implemented method of managing a work engagement with a prospective hire for a media production is provided, the method comprising: receiving a plurality of deal terms at a first server system, the plurality of deal terms sent from a remote manager computer over the Internet, the first server system comprising a microprocessor and a non-transitory memory that stores the plurality of deal terms; retrieving by the first server system production information relating to the media production; transmitting by the first server system for display on the manager computer a deal summary comprising at least some of the plurality of deal terms and at least some of the production information; transmitting an onboarding message to the prospective hire, the onboarding message including a link to an onboarding application; receiving over the Internet a request for access to the onboarding application; executing the onboarding application. The execution of the onboarding application comprises: transmitting a request for personal information to the prospective hire computer; receiving personal information from the prospective hire computer; transmitting work engagement information to the prospective hire computer, the work engagement information including work engagement policies and at least some of the plurality of deal terms; and receiving confirmation of approval of the work engagement information from the prospective hire computer; and executing an approver interface, the executing the approver interface comprising: transmitting for display on an approver computer information about the prospective hire; and receiving from the approver computer an indication of approval of the work engagement with the prospective hire.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modification in various respects, all without departing from the spirit and the scope of the present invention. Accordingly, the drawings and detailed description are to be regarded as illustrative in nature and not as restrictive.

### BRIEF DESCRIPTION OF DRAWINGS

FIG. 1 is a flowchart illustrating a method of managing work engagements for a media production, in accordance with embodiments of the present invention.

FIG. 2 is a block diagram illustrating an example environment 200 in which embodiments of the present invention may be implemented.

FIGS. 3A-3D are illustrative screenshots of the creation of a work engagement by a hiring manager, in accordance with embodiments of the present invention.

FIGS. 4A-4G are illustrative screenshots of the onboarding application for use by the prospective hire to review and accept the terms of a work engagement, in accordance with embodiments of the present invention.

FIGS. 5A-5E are illustrative screenshots of an approval application for use by the approver to review and approve a work engagement accepted by the prospective hire, in accordance with embodiments of the present invention.

FIG. 6 illustrates an exemplary block diagram of a computing device which may be used in accordance with embodiments of the present invention.

### DETAILED DESCRIPTION

In the following description, reference is made to the accompanying drawings that illustrate several embodiments of the present disclosure. It is to be understood that other embodiments may be utilized and system or process changes may be made without departing from the spirit and scope of the present disclosure. The following detailed description is not to be taken in a limiting sense, and the scope of the embodiments of the present invention is defined only by the claims of the issued patent. It is to be understood that drawings are not necessarily drawn to scale.

Various embodiments of the present disclosure provide improved systems and methods for managing work engagements for a media production using online systems over the Internet. These embodiments may provide more effective and reliable management of the various tasks, processes, communications, and responsibilities undertaken by a studio, production, and production workers, as well as overcoming various technical challenges presented if attempting to provide online systems for managing such work engagements using electronic documentation.

In the entertainment industry, when starting a new production, such as a film, television or commercial production, a large number of personnel must be hired to perform the various functions required to complete the production. For each member of the production, the producers of the production must create, distribute, track, review, correct, submit and file numerous forms and other employment paperwork, and ensure ongoing compliance with all applicable regulations. In all productions, these processes are performed manually with the distribution and handling of hard copies of the various employment documents. The use of electronic documentation and electronic communication, such as e-mails or texting, can provide some benefits; however, this creates new technical challenges for the production workers and producers, such as the challenges of tracking and managing of communications from various sources.

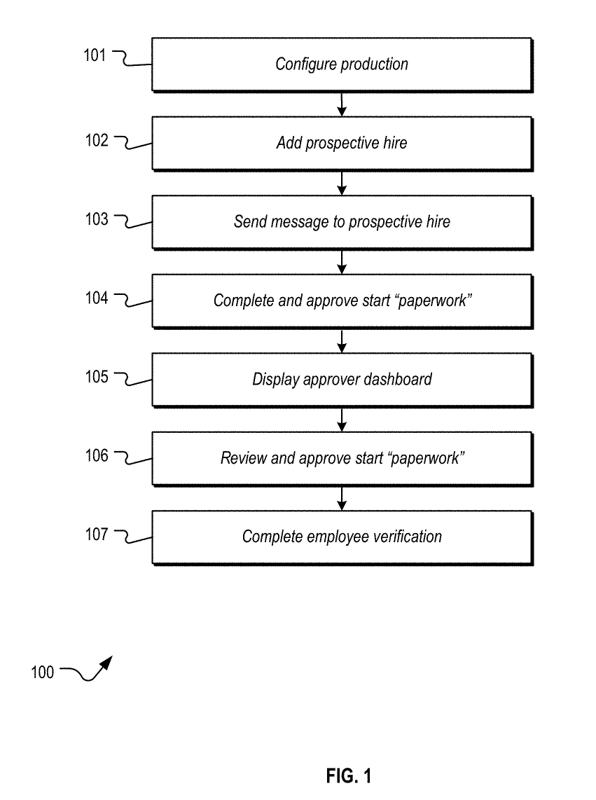

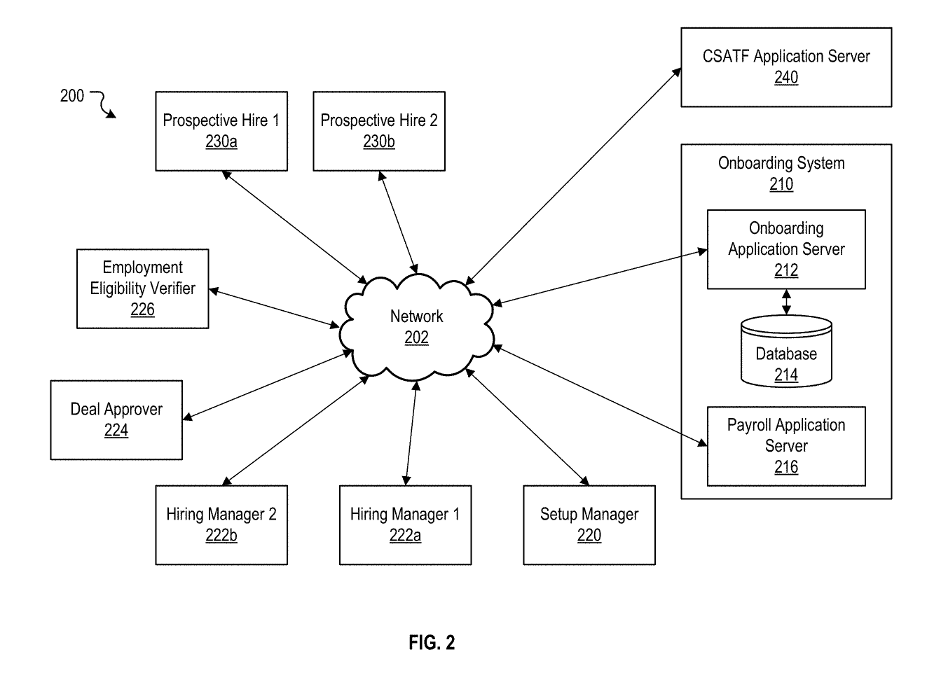

FIG. 1 is a flowchart illustrating a method 100 of managing work engagements for a media production, in accordance with embodiments of the present invention. FIG. 2 is a block diagram illustrating an example environment 200 in which embodiments of the present invention may be implemented. The environment 200 includes an onboarding system 210, which may be implemented using one or more onboarding application server systems 212, optionally coupled to one or more databases 214 and one or more payroll servers 216, as will be described in greater detail below. The system 210 can communicate with other computing devices over a network 202. The network 202 can be, e.g., the Internet, intranets, extranets, wide area networks (WANs), local area networks (LANs), wired networks, wireless networks, mobile communications networks, or other networks suitable for electronic communication, or any combination of two or more such networks.

In step 101, a setup manager 220 (shown in FIG. 2) creates the initial setup of the production in the onboarding system 210. This can be accomplished remotely by the setup manager using a computing device, such as, e.g., a desktop, laptop, or tablet computer, communicating with the onboarding system 210 over the network 202. Although any type of software may be used to facilitate the initial setup, in some embodiments, users will interact with the onboarding system 210 via a browser application or a dedicated non-native, web-based mobile device software app. In one embodiment, setup manager 220 utilizes a browser application on the manager's computing device to access a setup application provided by the application server 212. The setup manager 220 can create or modify various parameters of the onboarding system 210, such as identifying the hiring managers 222 authorized to create and/or staff job positions, the approvers 224 authorized to approve the hiring of production workers for those job positions, and the employment eligibility verifiers 226 for verifying employment documentation of the new production workers, as will be described in greater detail below. In other embodiments, greater or fewer approvers may be used for various tasks. In addition, the setup manager 220 may also enter the start and end dates of the production, one or more worksite locations, studio name and address, production entities on the show, departments, general ledger formatting, payroll schedule, allowances and rentals to be offered to production workers, and other production information, which can be used by the hiring managers 222 when creating work engagements. The setup manager 220 may also upload to the application server 212 files containing the production's policies and procedures. It is to be understood that the various responsibilities of the setup manager 220 may be performed by a single individual or by multiple designated individuals, and can be, for example, a producer, studio executive, or an assistant to the producer or studio executive.

In step 102, the hiring manager 222 can create one or more work engagements for the production. For a film production, these work engagements comprise the various job positions for members of the crew for the production. In some embodiments, a plurality of hiring managers may be used (e.g., hiring managers 222a-222b), with each hiring manager having responsibility for the hiring of a portion of the crew, such as a specific production department or location.

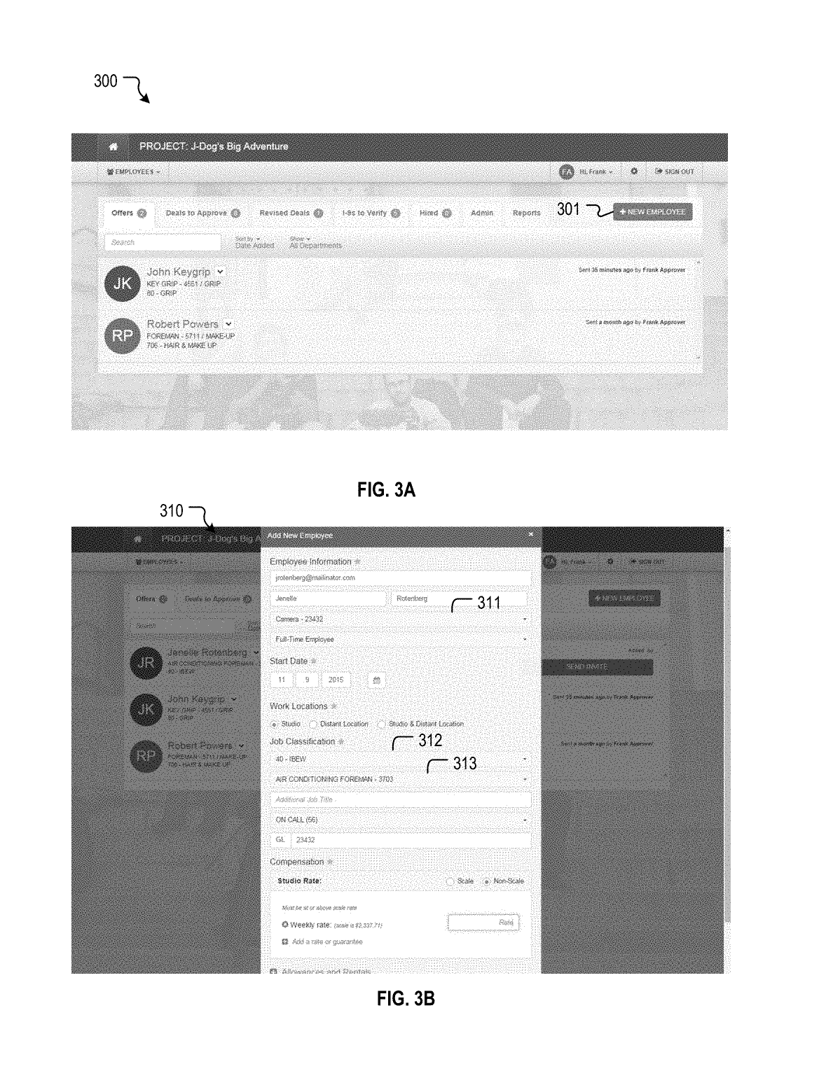

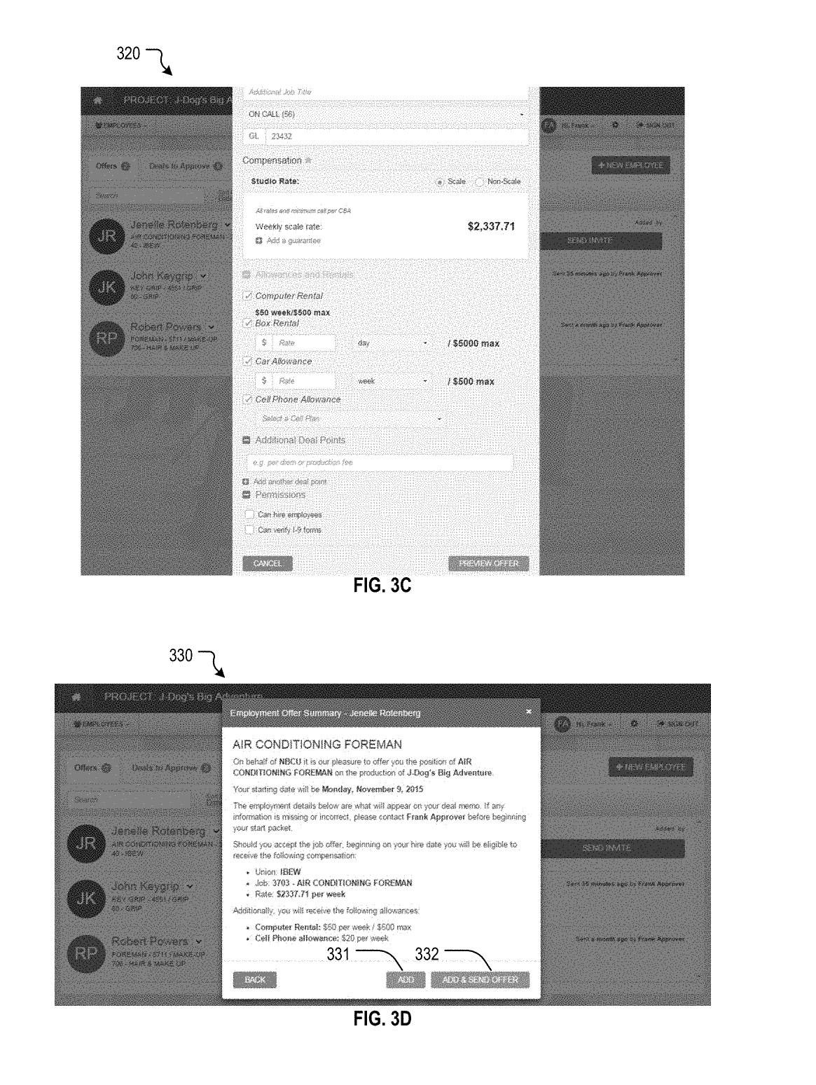

FIGS. 3A-3D are illustrative screenshots of the creation of a work engagement by a hiring manager 222, in accordance with embodiments of the present invention. FIG. 3A shows a hiring manager dashboard 300 generated by the onboarding application server 212 and accessed by a hiring manager 222a using a browser application over the Internet. It is to be understood that in other embodiments, the hiring manager dashboard 300 as well as other user interfaces described herein may vary, and greater, fewer, or different controls and information may be provided. The dashboard 300 shown in FIG. 3A displays a list of prospective hires to whom work engagement offers have been sent. If the hiring manager 222a wishes to create a new work engagement, the manager 222a may select the Add New Employee button 301. This causes the onboarding application server 212 to display an “Add New Employee” window, shown in FIG. 3B. The “Add New Employee” window contains various fields for receiving inputs from the hiring manager 222a regarding the terms of the work engagement.

The first portion 310 of the “Add New Employee” window contains fields for receiving deal term information from the hiring manager 222a, such as, e.g., email address, name, employment start date, job classification information, employment status (e.g., full-time, part-time, variable, seasonal, etc.), work location (e.g., studio location, remote location), and compensation information.

In some embodiments, the fields comprise drop-down menus providing only options entered by the setup manager 220 during the initial production setup. For example, in the portion requesting work location information, the “Add New Employee” window may require that the hiring manager 222a select from only those work locations pre-identified by the setup manager 220.

In the illustrated embodiment, the third field in the employee information portion includes a department field 311, in which the hiring manager 222a identifies the applicable production department for the prospective hire. The first field in the job classification portion includes a union identification field 312. Many media productions use a unionized workforce having predetermined job titles and employment terms, and may be signatory to one or more different unions. The titles and terms may vary between different unions, so that when the hiring manager 222a identifies the applicable union in the union identification field 312, this information is used by the server 212 to establish certain terms or other parameters for that prospective hire. For example, the next pull-down menu 313 requests the job title for the prospective hire. The hiring manager 222a is presented with a pull-down menu containing only the job titles applicable for the department and union selected by the hiring manager 222a in fields 311-312. These job titles may be retrieved by the onboarding server 212 from the database 214, which stores information about each position in each union. Alternatively, the job titles may be retrieved by the onboarding server 212 from a payroll application server 216 or other application server.

The payroll application server 216 may provide various payroll services to the production and can include its own database storing information for the various job titles in the different unions. The payroll application server 216 may be part of the onboarding system 210 or may be provided by a third party service provider.

Next, the hiring manager 222a selects the work schedule for the prospective hire. Based on the deal terms selected by the hiring manager 222a, the system 210 retrieves the applicable compensation rate from, e.g., the database 214, and displays the rate for review by the hiring manager 222a. The hiring manager 222a may also be presented with an option to enter a non-scale compensation rate for the prospective hire that differs from the predefined scale rate.

The second portion 320 of the “Add New Employee” window, shown in FIG. 3C, contains fields for receiving allowances and rental term information from the hiring manager 222a, such as, e.g., compensation for computer rental, box rental, car allowance, cell phone allowance, or other deal points for the work engagement.

After the hiring manager 222a completes the entry of the deal terms, the system 210 can generate a preview 330 of the employment offer for review by the hiring manager 222a before sending the offer to the prospective hire, as shown in FIG. 3D. If the hiring manager 222a has failed to enter any required deal terms, the system 210 will display a notification indicating the deficiency and prompting the hiring manager 222a to enter the required term.

Finally, if the hiring manager 222a is satisfied with the preview 330, in step 103, the hiring manager 222a can press the Add button 331, which will create the position in the system. This position can then be accessed by another user, such as a different hiring manager, for final review and transmission to the prospective hire. Alternatively, the hiring manager 222a may press the Add & Send Offer button 332 to cause the server 212 to generate an electronic message to the prospective hire with a link to the onboarding website for the prospective hire.

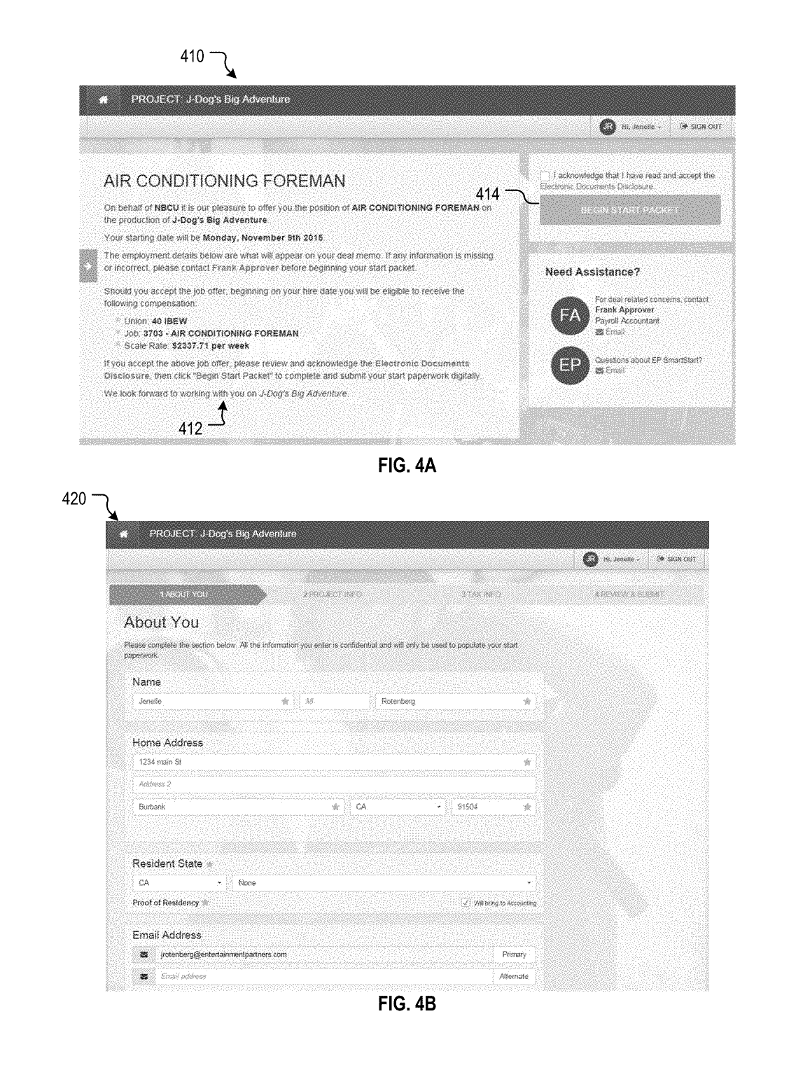

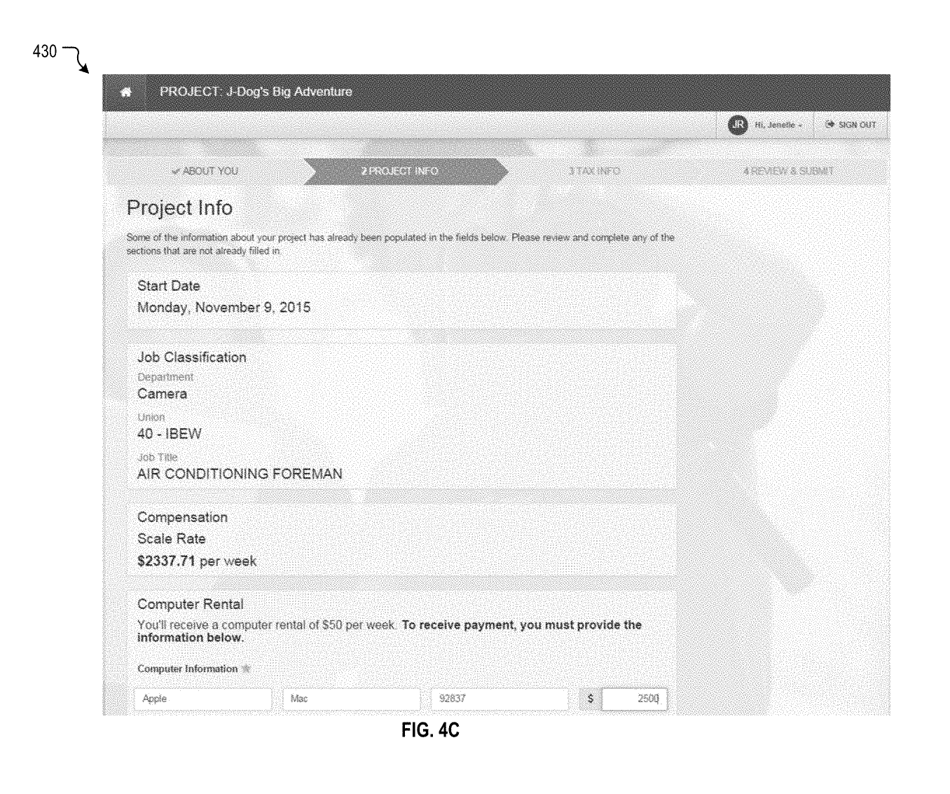

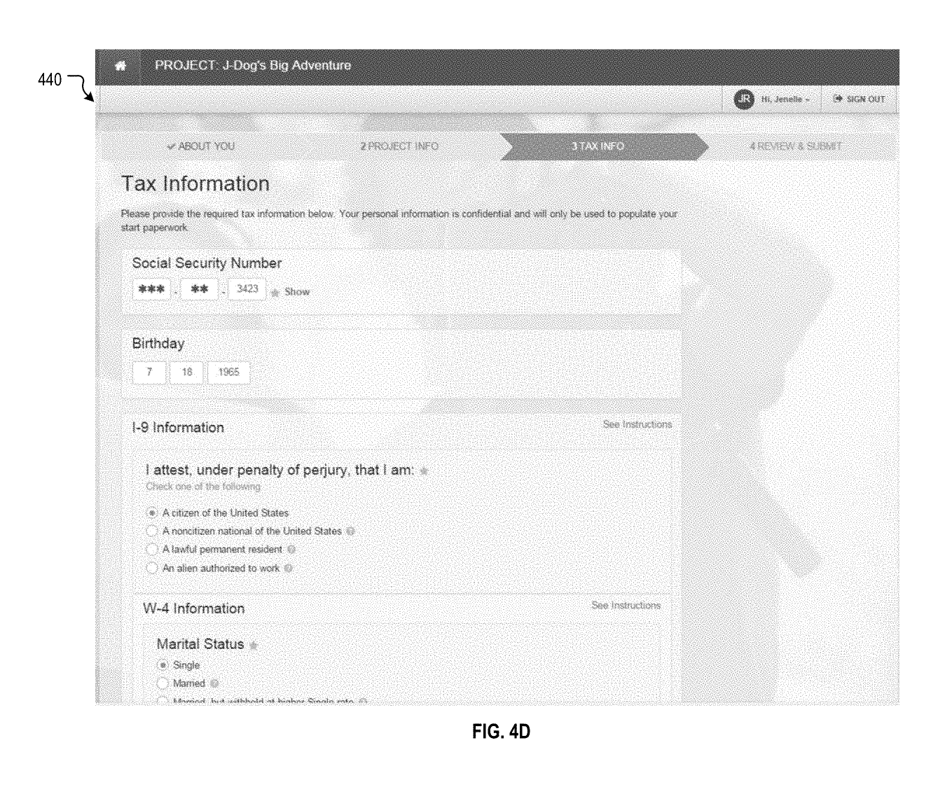

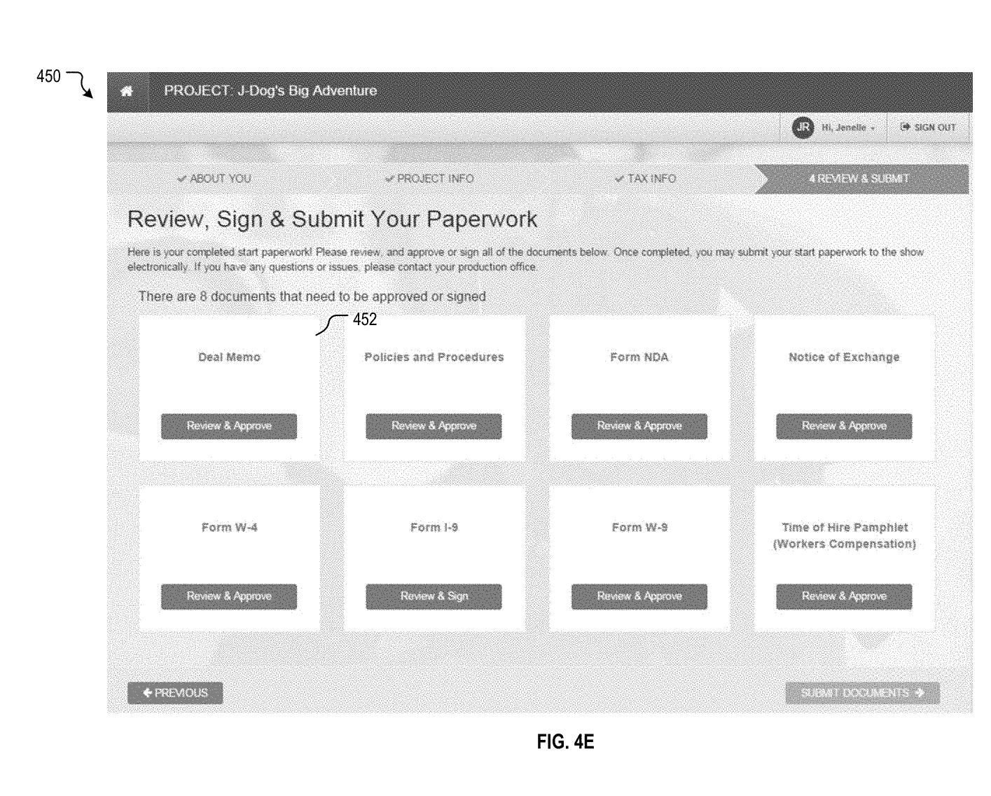

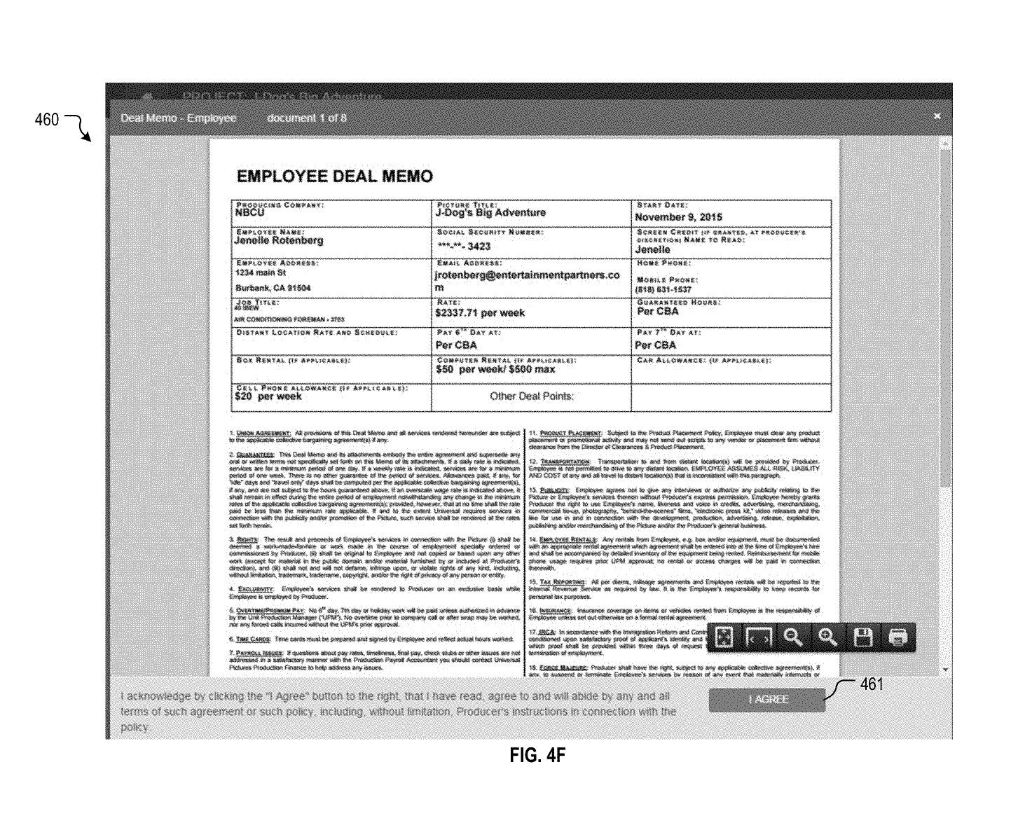

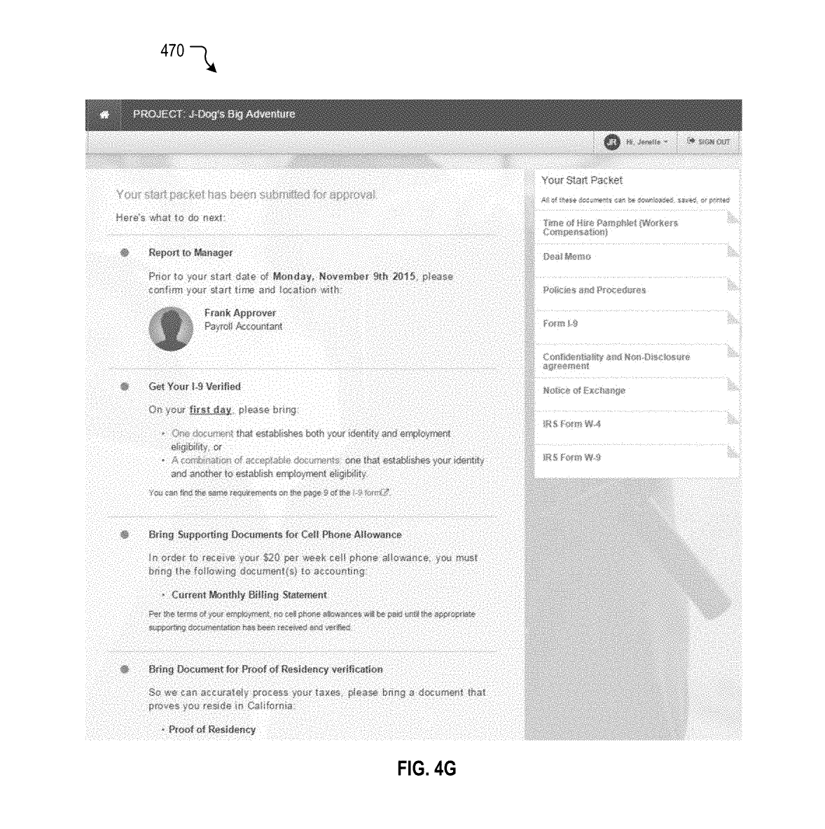

FIGS. 4A-4G are illustrative screenshots of the onboarding application for use by the prospective hire 230 to review and accept the terms of a work engagement, in accordance with embodiments of the present invention. As described above, after the hiring manager 222a completes the process of creating a new work engagement, an electronic message is transmitted to the prospective hire. In some embodiments, this message is an email sent to the email address entered by the hiring manager 222a. In other embodiment, different forms of electronic communication may be used, such as, e.g., a text message sent to the prospective hire's mobile phone number.

FIG. 4A shows the greeting page 410 of the onboarding application that the prospective hire 230a retrieves using a browser application on the prospective hire's computing device by following the hyperlink provided in the electronic message described above. The onboarding application may be generated by the onboarding application server 212. The greeting page 410 includes a summary section 412 displaying a summary of the work engagement being offered to the prospective hire 230a, including, e.g., the name of the production company, the prospective hire's job title, the title of the media production, the start date, and the compensation rate. The greeting page 410 includes a link 414 for the prospective hire 230a to follow to review and accept the “Electronic Documents Disclosure” and begin the “Start Packet.” In the illustrated embodiment, the Start Packet is the name for the documentation regarding the prospective hire's deal terms and other documentation related to the work engagement.

As shown in FIG. 4B, after the prospective hire 230a clicks the link 414, the onboarding application server 212 presents a personal information page 420, which contains various fields prompting the prospective hire 230a to enter personal information, such as, e.g., the prospective hire's full name, home address, email address, etc. The onboarding application server 212 uses this personal information to complete various documentation for the work engagement. In a typical hiring process, the prospective hire must complete numerous forms, many of which request duplicative information. In accordance with embodiments of the present invention, the prospective hire 230a can merely enter the information once, and the onboarding application server 212 can store that information in the database 214 for use in generating and/or populating the work engagement forms and for future use in other media productions.

FIG. 4C shows a project information summary page 430. This summary page 430 displays the work engagement information to the prospective hire 230a, including deal terms entered by the hiring manager 222a, as described above. The summary page 430 prompts the prospective hire 230a to review the work engagement information to confirm that all of the terms are in accordance with the prospective hire's expectations.

FIG. 4D shows a tax information page 440, which prompts the prospective hire 230a to enter additional personal information related to the applicable tax forms to be completed for the work engagement.

FIG. 4E shows a review page 450, which includes links to pages displaying details regarding the work engagement, documentation to be reviewed and approved by the prospective hire as part of the onboarding process, such as the policies and procedures for the production, as well as completed versions of the employment and tax forms incorporating the information inputted by the prospective hire 230a, as described above.

FIG. 4F shows a deal memo page 460 displayed when the prospective hire 230a clicks on the deal memo link 452 in the review page 450. The deal memo page 460 presents a completed work engagement offer, including the deal terms entered by the hiring manager 222a and the prospective hire 230a, as well as general terms for the production. In some embodiments, the deal memo page 460 is provided in a fixed-layout file format, such as, for example, the Portable Document Format (PDF), which can be downloaded and saved to the prospective hire's local computer. The deal memo page 460 may also present an acceptance button 461 to be selected by the prospective hire 230a to indicate acceptance of the terms presented in the deal memo page 460.

The onboarding application server 212 may then require that the prospective hire 230a follow all of the links on the review page 450, and review and accept the documentation associated with each link. After all of the required documentation is reviewed and accepted by the prospective hire, the prospective hire 230a is taken to the completion page 470, shown in FIG. 4G. The completion page 470 can include information regarding the next steps in the hiring process, next steps to be taken by the prospective hire, as well as links to copies of all of the prospective hire's engagement documents, such as the deal memo, production policies and procedures, Employment Eligibility Verification Form 1-9, Confidentiality and Non-Disclosure agreement, Notice of Exchange, IRS Form W-4, Employee's Withholding Allowance Certificate, and IRS Form W-9, Request for Taxpayer Identification Number and Certification. The prospective hire 230a may return to the onboarding application at a future date to retrieve copies of these documents, and review and approve any changes to the deal terms, as will be described in more detail below.

The Contract Services Administration Trust Fund (“CSATF”) administers a variety of programs for the benefit of the motion picture and television industry, including the administration and maintenance of the Industry Experience Roster (“IER”). The IER contains the work experience and other requirements for each production worker based on the applicable union collective bargaining agreement. In some embodiments, after the prospective hire 230a reviews and approves the required documentation, the onboarding application server 212 may retrieve additional information about the prospective hire to confirm the status of one or more hiring requirements for that prospective hire 230a. For example, the onboarding application server 212 may transmit a query to an application server 240 managed by the CSATF requesting status information for that prospective hire. If the CSATF application server 240 indicates that the prospective hire does not satisfy the requirements for the proposed work engagement (e.g., the prospective hire has not completed training classes required for his job title), the onboarding application server 212 may transmit a notification of non-compliance to the applicable approver. That approver could then follow up with the prospective hire and/or the hiring manager to ensure that the prospective hire complies with all applicable union requirements or else be replaced by a different prospective hire.

After the prospective hire 230a reviews and approves the required documentation and, if applicable, the CSATF compliance is confirmed, the onboarding application server 212 routes the prospective hire's work engagement for approval by the deal approver 224 identified by the setup manager 220 or the hiring manager 222. In some cases, more than one deal approver may be required, in which case the onboarding application server 212 routes the prospective hire's work engagement to those approvers in series or parallel, depending on the desired routing procedures. In some cases, each approver 224 receives an electronic communication, such as an email, informing the approver 224 that there are work engagements awaiting that approver's review and approval.

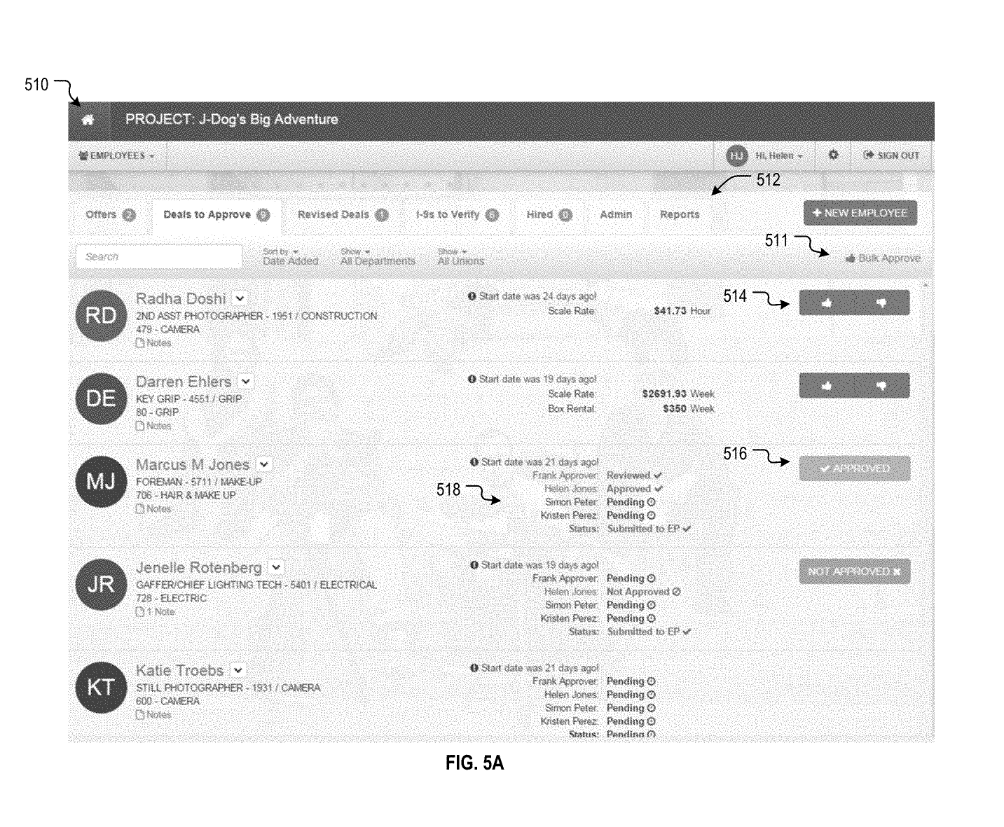

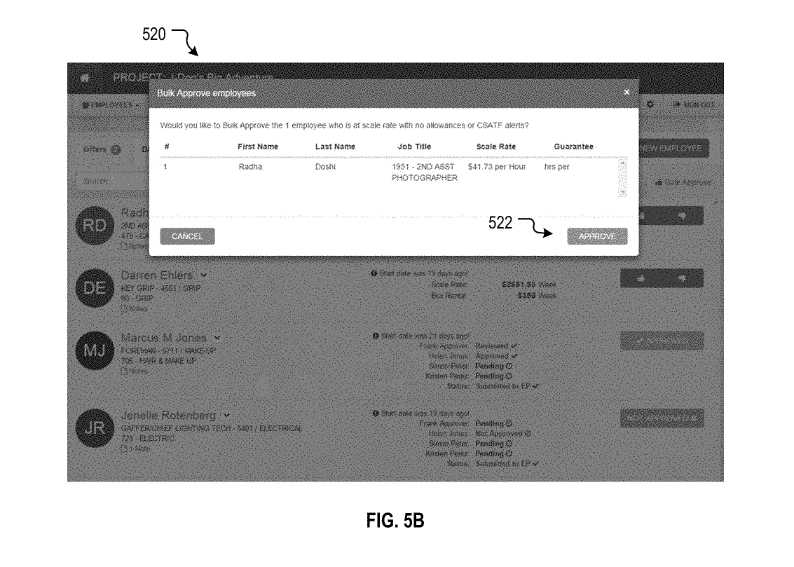

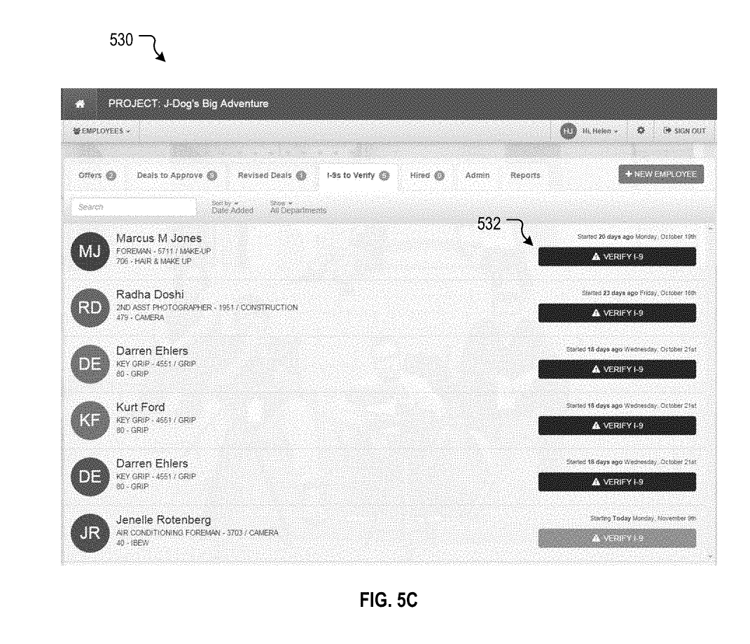

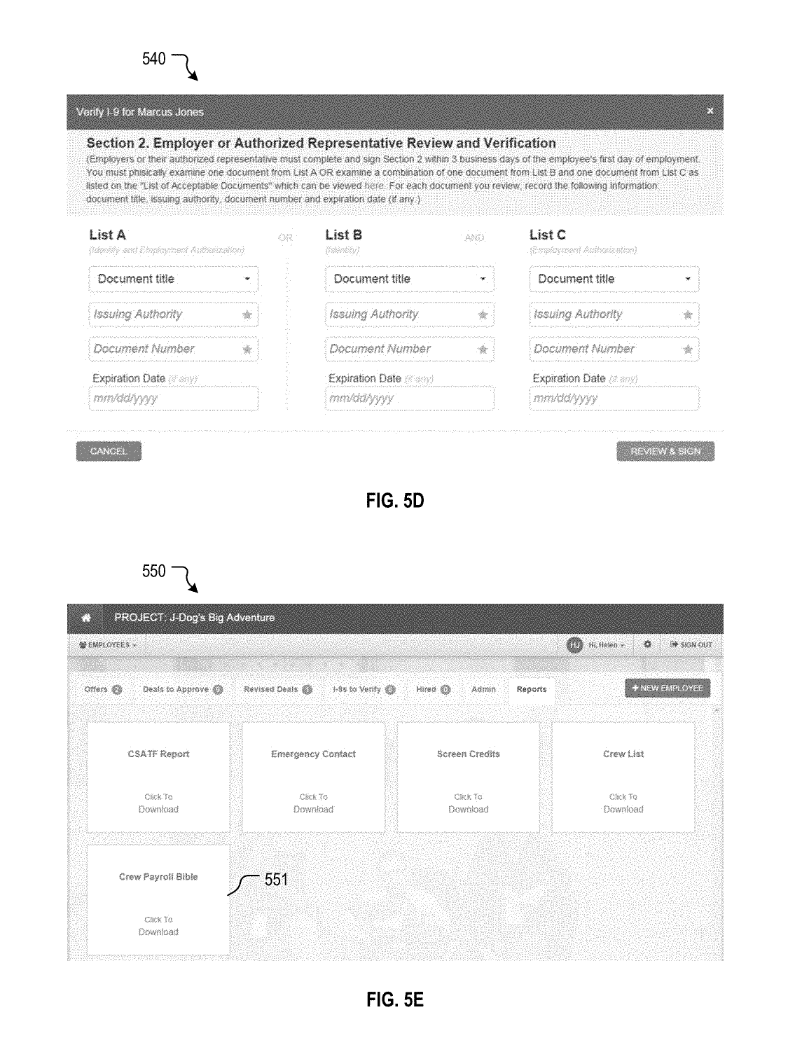

FIGS. 5A-5E are illustrative screenshots of an approval application for use by the approver 224 to review and approve a work engagement accepted by the prospective hire 230a, in accordance with embodiments of the present invention. As described above, after the hiring manager 222a completes the process of creating a new work engagement, and the prospective hire 230a reviews and approves the work engagement, the work engagement may be routed to one or more approvers 224 for final approval.

FIG. 5A shows an approver dashboard 510 generated by the onboarding application server 212 and accessed by an approver 224 using a browser application over the Internet. The approver dashboard 510 shown in FIG. 5A includes several tabs 512 for displaying various categories of information, including, e.g., prospective hires to whom work engagement offers have been sent (“Offers”), work engagements requiring approval (“Deals to Approve”), work engagements which have been previously approved but have been revised and require re-approval (“Revised Deals”), prospective hires for whom employment documentation must be verified (“I-9s to Verify”), all hired production workers (“Hired”), administrative information (“Admin”), and other reports regarding prospective hires and work engagements (“Reports”). In some embodiments, tabs relating to information and functions that the approver 224 is not authorized to access are not shown. For example, the “I-9s to Verify” and “Admin” tabs may be omitted in embodiments in which the approvers 224 are not authorized to verify I-9s and perform other administrative tasks normally provided under the “Admin” tab.

In FIG. 5A, the “Deals to Approve” tab is selected, and a list of prospective hires who have accepted their work engagements and are awaiting approval are displayed. The dashboard 510 may display summarized information about the work engagement (e.g., prospective hire name, job title, and compensation rate), and may include a link to cause the approval application to display detailed information regarding the work engagement. For any prospective hires awaiting that approver's approval, an approve/reject button 514 is displayed. The approver 224 may select the desired button to either approve or reject the work engagement. If rejected, the approval application may prompt the approver 224 to enter an explanation for the rejection. The hiring manager 222a and/or prospective hire 230a may receive an electronic communication alerting them about the rejection. If necessary, the approver 224 may modify the deal terms and re-route the work engagement to the prospective hire 230a and approver 224 for approval. In various embodiments, the ability to modify the deal terms may be restricted to certain individuals, such as the approver, hiring manager, or other manager or personnel involved with the onboarding process with the desired level of authority.

For the work engagements that have already been approved by approver 224, an “Approved” flag 516 is displayed, along with a list 518 of the status of the approvals from all of the required approvers for that work engagement. This enables the approver 224 to quickly review the status of the various work engagements proposed for the media production and to contact any outstanding approvers to request their approval, if needed.

The approval dashboard 510 also includes a bulk approval button 511 to enable any of the approvers 224 to approve multiple work engagements simultaneously. When the approver 224 selects the bulk approval button 511, a bulk approval window 520 is displayed, as shown in FIG. 5B. This bulk approval window 520 displays all of the work engagements which are currently awaiting that approver's approval for which the approver 224 is permitted to bulk approve. By selecting the Approve button 522, the approver 224 can approve all of those outstanding work engagements simultaneously. In some embodiments, the approver 224 is not permitted to bulk approve any work engagements containing non-standard deal terms, special allowances, or other special conditions. In this case, those work engagements would not be listed in the bulk approval window 520. In some embodiments, there may be restrictions on the ability of approvers 224 to approve multiple work engagements simultaneously. For example, the approvers 224 may only be able to bulk approve work engagements involving regular scale employees, whereas work engagements involving employees with special deal terms (e.g., allowances or box rentals) may not be bulk approved and must be approved individually. This can help to ensure that the approvers apply a greater level of scrutiny of the work engagements under certain situations (e.g., work engagements with special deal terms).

In the United States, employers are required to verify the identity and employment authorization for every production worker employee. Within three days of the production worker's first day of employment, the employer must verify the production worker's identity and employment authorization by physically examining evidence of identity and employment eligibility. This is accomplished by examining the production worker's passport or permanent resident card, or any other approved individual documents or combination of documents identified in the U.S. Citizenship and Immigration Services Form 1-9 list of acceptable documents. The onboarding system 210 can facilitate this verification process by providing an employee verification interface 530, as shown in FIG. 5C. The employment eligibility verifier 226, who may be the same or a different individual than the deal approver 224, utilizes this verification interface 530 to view a list of production workers requiring employment verification as well as production workers' start dates. After the employment eligibility verifier 226 has physically examined the appropriate documentation, the verifier 226 can select verification button 532 to confirm verification. In response, a verification page 540 is displayed. The verifier 226 will enter the necessary information from the production worker's documentation and confirm the verification. This causes the appropriate governmental form (Form 1-9) to be generated and stored in the database 214.

One challenge of existing paper-based systems is the difficulty of quickly gathering information regarding production workers and work engagements. Even when electronic documentation is used, it can be difficult to track and retrieve information saved in different locations. In accordance with embodiments of the present invention, any authorized individual (e.g., setup manager 220, hiring manager 222, deal approver 224, employment eligibility verifier 226, or other authorized personnel) can access the onboarding system to retrieve various reports. FIG. 5E shows an example report page 550, providing links to various reports. For example, the Crew Payroll Bible button 551 causes the onboarding system 210 to generate a detailed report (referred to as the “Bible Report”) of the engagement terms for the entire production crew. This Bible Report is used by payroll accountants and other studio personnel for audit and tracking purposes. The ability to quickly and repeatedly generate this and other reports on demand can enable significantly improved management of productions.

In some embodiments, the onboarding system 210 may utilize the information received from the prospective hire, setup manager, and/or hiring manager to retrieve tax rules applicable to the prospective hire's location of residence and/or work location during the production. These retrieved tax rules may then be transmitted to the payroll application server 216, which utilizes the applicable tax rules for that prospective hire to apply the correct tax requirements for that hire.

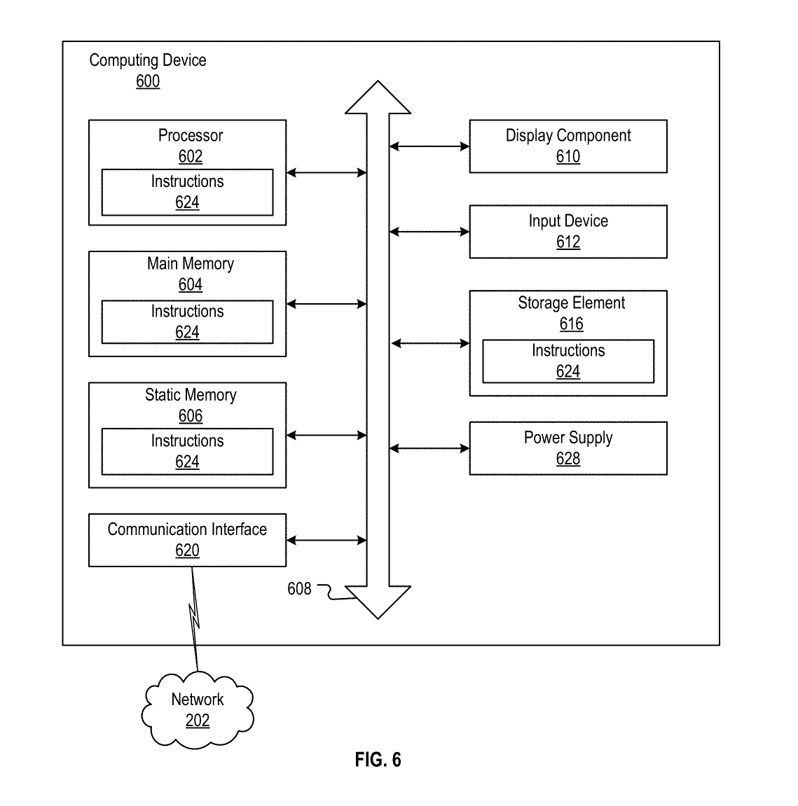

Referring to FIG. 6, the block diagram illustrates components of a computing device 600, according to some example embodiments, able to read instructions 624 from a non-transitory machine-readable storage medium (e.g., a hard drive storage system) and perform any one or more of the methodologies discussed herein, in whole or in part. Specifically, FIG. 6 shows the computing device 600 in the example form of a computer system within which the instructions 624 (e.g., software, a program, an application, an applet, an app, or other executable code) for causing the computing device 600 to perform any one or more of the methodologies discussed herein may be executed, in whole or in part.

In alternative embodiments, the computing device 600 operates as a single device or may be connected (e.g., networked) to other computing devices. In a networked deployment, the computing device 600 may operate in the capacity of a server computing device or a client computing device in a server-client network environment, or as a peer computing device in a distributed (e.g., peer-to-peer) network environment. The computing device 600 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any computing device capable of executing the instructions 624, sequentially or otherwise, that specify actions to be taken by that computing device. Further, while only a single computing device 600 is illustrated, the term “computing device” shall also be taken to include any collection of computing devices that individually or jointly execute the instructions 624 to perform all or part of any one or more of the methodologies discussed herein.

The computing device 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The computing device 600 may further include a display component 610. The display component 610 may comprise, for example, one or more devices such as cathode ray tubes (CRTs), liquid crystal display (LCD) screens, gas plasma-based flat panel displays, LCD projectors, or other types of display devices.

The computing device 600 may include one or more input devices 612 operable to receive inputs from a user. The input devices 612 can include, for example, a push button, touch pad, touch screen, keyboard, mouse, trackball, keypad, or any other such device or element whereby a user can provide inputs to the computing device 600. These input devices 612 may be physically incorporated into the computing device 600 or operably coupled to the computing device 600 via wired or wireless interface. For computing devices with touchscreen displays, the input devices 612 can include a touch sensor that operates in conjunction with the display component 610 to permit users to interact with the image displayed by the display component 806 using touch inputs (e.g., with a finger or stylus).

The computing device 611 may also include at least one communication interface 620, comprising one or more wireless components operable to communicate with one or more separate devices within a communication range of the particular wireless protocol. The wireless protocol can be any appropriate protocol used to enable devices to communicate wirelessly, such as Bluetooth, cellular, IEEE 802.11, or infrared communications protocols, such as an IrDA-compliant protocol. It should be understood that the communication interface 620 may also or alternatively comprise one or more wired communications interfaces for coupling and communicating with other devices.

The computing device 600 may also include a power supply 628, such as, for example, a rechargeable battery operable to be recharged through conventional plug-in approaches or through other approaches, such as capacitive charging. Alternatively, the power supply 628 may comprise a power supply unit which converts AC power from the power grid to regulated DC power for the internal components of the device 600.

The computing device 600 may also include a storage element 616. The storage element 616 includes the machine-readable medium on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the computing device 600. The instructions 624 may also reside in the static memory 606.

Accordingly, the main memory 604 and the processor 602 may also be considered machine-readable media (e.g., tangible and non-transitory machine-readable media). The instructions 624 may be transmitted or received over a network 202 via the communication interface 620. For example, the communication interface 620 may communicate the instructions 624 using any one or more transfer protocols (e.g., HTTP).

The computing device 600 may be implemented as any of a number of electronic devices, such as a tablet computing device, a smartphone, a media player, a portable gaming device, a portable digital assistant, a laptop computer, or a desktop computer. In some example embodiments, the computing device 600 may have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a non-transitory machine-readable medium capable of storing data temporarily or permanently and may be taken to include, but not be limited to, random-access memory (RAM), read-only memory (ROM), buffer memory, flash memory, and cache memory. The machine-readable medium is non-transitory in that it does not embody a propagating signal. While the machine-readable medium is described in example embodiments as a single medium, the term “machine-readable medium” should be taken to include a single medium or multiple media (e.g., a centralized or distributed database, or associated caches and servers) able to store instructions 624. The term “machine-readable medium” shall also be taken to include any medium, or combination of multiple media, that is capable of storing the instructions 624 for execution by the computing device 600, such that the instructions 624, when executed by one or more processors of the computing device 600 (e.g., processor 602), cause the computing device 600 to perform any one or more of the methodologies described herein, in whole or in part. Accordingly, a “machine-readable medium” refers to a single storage apparatus or device such as computing devices 110, 130, 140, or 150, as well as cloud-based storage systems or storage networks that include multiple storage apparatus or devices such as computing devices 110, 130, 140 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

While the invention has been described in terms of particular embodiments and illustrative figures, those of ordinary skill in the art will recognize that the invention is not limited to the embodiments or figures described. For example, in various embodiments described herein, the onboarding system can be accessed using a browser application on a desktop computer. In other embodiments, the onboarding system can be accessed using any of a variety of software applications and hardware devices, such as a tablet computer executing a dedicated onboarding application. In addition, in various embodiments described herein, the prospective hire is intended to be an employee of the production. In other embodiments, the prospective hire can be a consultant, contractor, employee of a third party entity, or any other desired work engagement.

Various embodiments of the present invention may achieve advantages not provided by existing paper-based processes or even onboarding processes using electronic documentation. The centralized storage and management of work engagement information as well as the status of approvals can prevent a production worker from beginning work without the necessary documentation or approvals. This can prevent disputes and litigation with the production workers and avoid violation of applicable laws and regulations. In addition, the system can provide a consistent process for documenting deals and addressing any inconsistencies between the production and the production worker as early as possible. The system also provides a consistent user interface for the various users of the system, even over extended periods of time and multiple productions. The retrieval of compensation rates and other deal terms from an updated database can provide improved accuracy and reduce the possibility of utilizing incorrect wages or job titles. The system may also improve the integrity of deal terms throughout the onboarding process by preventing changes to the deal terms without notification and confirmation by the production worker. The system may also provide the producers of the media production with reporting capabilities for the entire production, thereby providing improved visibility into non-standard deal terms being provided to production workers. The system may also provide a streamlined approval process, with approvals being routed in parallel and with fewer opportunities for missing, incorrect or illegible data. By requiring review and approval of work engagement policies by the prospective hire, the system may provide increased compliance with studio policies and applicable laws and regulations.

Embodiments of the present invention may also provide a more secure method of handling the employee onboarding process than current paper processes. All sensitive documents, such as personal information and employment data, may be stored in secure servers, with access only provided to those with appropriate authorization to do so. In addition, the use of role-based authorizations for accessing and approving various documents and information can further improve security and reduce the likelihood that an unauthorized individual would be exposed to sensitive employee data. In addition, although embodiments described above utilize different people for each of the different roles in the onboarding process (e.g., hiring managers 222, approvers 224, and employment eligibility verifiers 226), in other embodiments, a single individual may serve on two or more roles. For example, the same person may serve as the hiring manager 222, approver 224, and employment eligibility verifier 226, and can utilize each of the dashboards described above to complete the tasks associated with that role.

In accordance with some embodiments, the functions performed by the database 214 described above may be performed by a single server or multiple servers, and with a single software application or multiple applications. In one embodiment, the database 214 comprises a contract rates database, which stores information about job titles and their associated pay rates, and a tax engine database, which can provide the tax rules applicable to each prospective hire's location of residence and/or work location during the production.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments. Specific elements of any embodiments can be combined or substituted for elements in other embodiments.

Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A computer-implemented method of managing a work engagement with a prospective hire for a media production, the method comprising:
receiving a plurality of deal terms at a first server system, the plurality of deal terms sent from a remote manager computer over the Internet, the first server system comprising a microprocessor and a non-transitory memory that stores the plurality of deal terms;
retrieving by the first server system production information relating to the media production;
transmitting by the first server system for display on the manager computer a deal summary comprising at least some of the plurality of deal terms and at least some of the production information;
transmitting an onboarding message to the prospective hire, the onboarding message including a link to an onboarding application;
receiving over the Internet a request for access to the onboarding application;
executing the onboarding application, the executing the onboarding application comprising:
transmitting a request for personal information to the prospective hire computer;
receiving personal information from the prospective hire computer;
transmitting work engagement information to the prospective hire computer, the work engagement information including work engagement policies and at least some of the plurality of deal terms; and
receiving confirmation of approval of the work engagement information from the prospective hire computer; and
executing an approver interface, the executing the approver interface comprising:
transmitting for display on an approver computer information about the prospective hire; and
receiving from the approver computer an indication of approval of the work engagement with the prospective hire.

2. The method according to claim 1, wherein the plurality of deal terms includes a job title, the method further comprising:
retrieving from a remote computing device compensation terms corresponding to the job title in accordance with union negotiated rates.

3. The method according to claim 1, wherein the retrieving by the first server system production information relating to the media production comprises:
retrieving by the first server system information regarding a union affiliation for the media production; and
retrieving by the first server system information regarding deal terms corresponding to the union affiliation for the media production.

4. The method according to claim 1, wherein:
the transmitting for display on the approver computer information about the prospective hire comprises transmitting for display on the approver computer a compensation rate and job title.

5. The method according to claim 1, wherein:
the transmitting for display on the approver computer information about the prospective hire comprises transmitting for display on the approver computer a status of approvals for the work engagement with the prospective hire.

6. The method according to claim 1, wherein executing the approver interface comprises:
receiving from the approver computer a request to display additional information about the prospective hire; and
transmitting for display on the approver computer at least some of the plurality of deal terms.

7. The method according to claim 1, wherein the executing the approver interface comprises:
transmitting for display on the approver computer information about a plurality of prospective hires; and
receiving from the approver computer an indication of approval of work engagements with all of the plurality of perspective hires.

8. The method according to claim 1, further comprising executing an employee verification interface, the executing the employee verification interface comprising:
identifying that a current date corresponds to a start date for an employee;
displaying a notification to verify employee documentation; and
receiving information corresponding to the employee documentation.

9. The method according to claim 1, wherein the receiving personal information from the prospective hire computer comprises receiving information regarding a residence location for the prospective hire or a production location for the media production, the method further comprising:
retrieving tax rules corresponding to the residence location for the prospective hire or the production location for the media production.

10. The method according to claim 1, further comprising:
receiving modified deal point information; and
transmitting an electronic communication to an approver requesting approval of the modified deal point information.

11. The method according to claim 1, further comprising:
receiving a second plurality of engagement terms at the first server system, the second plurality of engagement terms corresponding to a second media production;
retrieving by the first server system the personal information from the prospective hire; and
transmitting a second work engagement information to the prospective hire, the second work engagement information including the retrieved personal information from the prospective hire.

12. A workforce management system, comprising:
a processor; and
a non-transitory computer-readable memory storing computer-executable instructions which when executed cause the processor to perform a method comprising:
receiving a plurality of deal terms at a first server system, the plurality of deal terms sent from a remote manager computer over the Internet, the first server system comprising a microprocessor and a non-transitory memory that stores the plurality of deal terms;
retrieving by the first server system production information relating to the media production;
transmitting by the first server system for display on the manager computer a deal summary comprising at least some of the plurality of deal terms and at least some of the production information;
transmitting an onboarding message to the prospective hire, the onboarding message including a link to an onboarding application;
receiving over the Internet a request for access to the onboarding application;
executing the onboarding application, the executing the onboarding application comprising:
transmitting a request for personal information to the prospective hire computer;
receiving personal information from the prospective hire computer;
transmitting work engagement information to the prospective hire computer, the work engagement information including work engagement policies and at least some of the plurality of deal terms; and
receiving confirmation of approval of the work engagement information from the prospective hire computer;
executing an approver interface, the executing the approver interface comprising:
transmitting for display on an approver computer information about the prospective hire; and
receiving from the approver computer an indication of approval of the work engagement with the prospective hire.

13. The system according to claim 12, wherein the plurality of deal terms includes a job title, and the computer-executable instructions further cause the processor to:
retrieve from a remote computing device compensation terms corresponding to the job title in accordance with union negotiated rates.

14. The system according to claim 12, wherein the computer-executable instructions cause the processor to receive production information relating to the media production by:
retrieving by the first server system information regarding a union affiliation for the media production; and
retrieving by the first server system information regarding deal terms corresponding to the union affiliation for the media production.

15. The system according to claim 12, wherein the computer-executable instructions cause the processor to transmit for display on the approver computer a compensation rate and job title.

16. The system according to claim 12, wherein the computer-executable instructions cause the processor to:
transmit for display on the approver computer a status of approvals for the work engagement with the prospective hire.

17. The system according to claim 12, wherein the computer-executable instructions cause the processor execute the approver interface by:
receiving from the approver computer a request to display additional information about the prospective hire; and
transmitting for display on the approver computer at least some of the plurality of deal terms.

18. The system according to claim 12, wherein the computer-executable instructions cause the processor execute the approver interface by:
transmitting for display on the approver computer information about a plurality of prospective hires; and
receiving from the approver computer an indication of approval of work engagements with all of the plurality of perspective hires.

19. The system according to claim 12, wherein the computer-executable instructions further cause the processor to execute an employee verification interface by:
identifying that a current date corresponds to a start date for an employee;
displaying a notification to verify employee documentation; and
receiving information corresponding to the employee documentation.

20. The system according to claim 12, wherein the computer-executable instructions further cause the processor to:
receive information regarding a residence location for the prospective hire or a production location for the media production; and
retrieve tax rules corresponding to the residence location for the prospective hire or the production location for the media production.
